(19) United States
(12) Patent Application Publication
(10) Pub. No.: US 2024/0307765 A1
(43) Pub. Date: Sep. 19, 2024

(54) MAP SWITCHING METHOD AND APPARATUS, SERVER, STORAGE MEDIUM, AND PROGRAM PRODUCT

(71) Applicant: Tencent Technology (Shenzhen) Company Limited, Shenzhen (CN)

(72) Inventors: Xiaoqiang HU, Shenzhen (CN); Hao Huang, Shenzhen (CN); bin Qiu, Shenzhen (CN); Chuhuan Feng, Shenzhen (CN); Xuan Wang, Shenzhen (CN)

(21) Appl. No.: 18/670,644

(22) Filed: May 21, 2024

Related U.S. Application Data
(63) Continuation of application No. PCT/CN2023/092909, filed on May 9, 2023.

(30) Foreign Application Priority Data
Jun. 28, 2022 (CN) 202210749617.8

(51) Int. Cl. A63F 13/352; A63F 13/71; A63F 13/77; H04L 67/148

(52) U.S. Cl. CPC A63F 13/352; A63F 13/71; A63F 13/77; H04L 67/148

(57) ABSTRACT

Embodiments of this application provide a virtual map switching method performed by a computer device. The method includes: receiving a map switching request transmitted by a client, the map switching request instructing to switch the client from a first map corresponding to a first map server to a second map corresponding to a second map server; transmitting session data and character data to the second map server in response to the map switching request, the session data instructing the second map server to create a session with the client, and the character data instructing the second map server to create a virtual character in the second map; and transmitting a second map switching response to the client, the second map switching response instructing the client to perform the session with the second map server to control the virtual character in the second map.

### CROSS-REFERENCE TO RELATED APPLICATIONS

This application is a continuation application of PCT Patent Application No. PCT/CN2023/092909, entitled “MAP SWITCHING METHOD AND APPARATUS, SERVER, STORAGE MEDIUM, AND PROGRAM PRODUCT” filed on May 9, 2023, which claims priority to Chinese Patent Application No. 202210749617.8, entitled “MAP SWITCHING METHOD AND APPARATUS, SERVER, STORAGE MEDIUM, AND PROGRAM PRODUCT” filed on Jun. 28, 2022, all of which is incorporated by reference in its entirety.

### FIELD OF THE TECHNOLOGY

This application relates to the technical field of computers, and in particular, to a map switching method and apparatus, a server, a storage medium, and a program product.

### BACKGROUND OF THE DISCLOSURE

With the development of gaming technologies, in a massive multiplayer online game (MMOG), when a player needs to switch from one map to another, the two maps may correspond to different servers.

In the related art of map switching, a client first disconnects from a source server and then establishes a connection with a target server. Disconnection may occur to the client in a process of disconnecting a current connection and establishing a new connection, resulting in a low effectiveness of map switching.

### SUMMARY

Embodiments of this application provide a map switching method and apparatus, a server, a computer-readable storage medium, and a computer program product, which can enhance the data security and the convenience of system security maintenance while improving the effectiveness of map switching.

Technical solutions in the embodiments of this application are implemented in the following.

An embodiment of this application provides a virtual map switching method performed by a computer device acting as a scheduling server, including:
receiving a map switching request transmitted by a client, the map switching request instructing to switch the client from a first map corresponding to a first map server to a second map corresponding to a second map server;
transmitting session data and character data to the second map server in response to the map switching request, the session data instructing the second map server to create a session with the client, and the character data instructing the second map server to create a virtual character in the second map; and
transmitting a second map switching response to the client, the second map switching response instructing the client to perform the session with the second map server to control the virtual character in the second map.

An embodiment of this application provides a computer device acting as a scheduling server, including:
a memory, configured to store an executable instruction; and
a processor, configured to implement, when executing the executable instruction stored in the memory, the virtual map switching method according to the embodiments of this application.

An embodiment of this application provides a non-transitory computer-readable storage medium, having an executable instruction stored therein, and the executable instruction, when executed by a processor of a computer device, causing the computer device to implement the virtual map switching method according to the embodiments of this application.

An embodiment of this application provides a computer program product, having a computer program or instruction stored therein, and the computer program or instruction, when executed by a processor, causing the processor to implement the map switching method according to the embodiments of this application.

The embodiments of this application have the following beneficial effects:

By coordinated operations of the scheduling server and the access server in the process of map switching of the client, the client maintains the current network connection with the access server in the process of switching from the first map to the second map, and by setting, by the access server, the route for the client to point to the second map server, switching from the first map to the second map is implemented. Therefore, disconnection that may occur to the client in the process of disconnecting a current connection and establishing a new connection is avoided, thereby improving the stability and efficiency of map switching. In addition, the entire switching process is controlled by the scheduling server, so that a security issue can be quickly located, while the data security of the switching is ensured, thereby further improving the convenience of system security maintenance.

### BRIEF DESCRIPTION OF THE DRAWINGS

FIG. 1 is a schematic architectural diagram of a map switching system 100 according to an embodiment of this application.

FIG. 2 is a schematic structural diagram of a scheduling server 200 according to an embodiment of this application.

FIG. 3A to FIG. 3E are schematic flowcharts of a map switching method according to an embodiment of this application.

FIG. 4A and FIG. 4B are schematic diagrams of a process for selecting a target map server according to an embodiment of this application.

FIG. 5 is a schematic flowchart of a map switching method according to an embodiment of this application.

FIG. 6 is a schematic diagram of a process for selecting a target map server according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following description, the term “some embodiments” describes subsets of all possible embodiments, but “some embodiments” may be the same subset or different subsets of all the possible embodiments, and can be combined with each other without conflict.

In the embodiments of this application, relevant data related to user login accounts is involved. When the embodiments of this application are applied to products or technologies, user permission or consent is required, and the collection, use, and processing of relevant data need to comply with relevant laws, regulations, and standards of relevant countries and regions.

In the following descriptions, the terms “first/second/third” involved are merely intended to distinguish between similar objects rather than describe specific orders. The terms “first/second/third” termed in such a way is interchangeable in proper circumstances, so that the embodiments of this application described herein can be implemented in order other than those illustrated or described herein.

In the following description, the term “plurality of” refers to at least two.

Unless otherwise defined, meanings of all technical and scientific terms used in this specification are the same as those usually understood by a person skilled in the art to which this application belongs. The terms used in the specification of this application are merely intended to describe objectives of the embodiments of this application, but are not intended to limit this application.

Before the embodiments of this application are further described in detail, a description is made on nouns and terms in the embodiments of this application, and the nouns and terms in the embodiments of this application are applicable to the following explanations.
1) In response to: The term is used to represent a condition or state on which a performed operation depends, and when the dependent condition or state is met, one or more operations performed may be in real time or have a set delay; unless otherwise specified, there is no restrictions on the order of a plurality of operations performed.
2) Virtual scene: It is a scene displayed (or provided) by a game program when run on a terminal device. The scene may be a simulated environment of the real world, a semi-simulated and semi-fictional environment, or a purely fictional virtual environment. The virtual scene may be any one of a two-dimensional virtual scene, a 2.5-dimensional virtual scene, or a three-dimensional virtual scene. The dimensions of the virtual scene is not limited in the embodiments of this application. For example, the virtual scene may include sky, land, or ocean, the land may include environmental elements such as deserts and cities, and a user may control a virtual object to move in the virtual scene.
3) Map instance: It is a game map program run on a map server, and is responsible for providing a game map scene. It is a map for controlling, according to an instruction transmitted by a game client, a player to enter a particular scene, for example, a forest map or school map having gameplay logic.
4) Map server: It is responsible for actually creating a map instance and controlling game interaction logic.
5) Access server: It is configured to maintain a network connection between a client and a map server.
6) Scheduling server: It serves as a central control node, and is responsible for controlling map servers in a map server cluster.

In implementation of map switching, the related art is mainly focused on disconnecting a client from a source server and then establishing a connection with a target server, to implement the map switching between servers. It has been found by the applicant that the technical solutions of the related art have the following shortcomings:
1. Poor network fault tolerance: The foregoing map switching process involves disconnecting a connection between a client and a source server and establishing a new connection with a target server. Since establishment of the new connection is involved, there are various factors which may cause a failure in the establishment of the connection, in particular, when a mobile network signal is poor or during handover of a base station, which may lead to a failure in map switching for a player.
2. High back-end data pressure: Switching of a player from the source server to the target server involves two database operations: saving data and reading data. If a large number of players frequently perform map switching, the pressure of a back-end database may increase and the delay in a map switching process increases.
3. Poor robustness: The foregoing map switching process depends on the client to first disconnect the connection from the source server and then establish the connection with the target server, which requires driving by the client. Moreover, the client is an external system outside the back-end system. If a problem occurs in the client, such as script errors and crashes, the map switching process cannot be continued.
4. Difficult to maintain: The foregoing image cutting process does not include a central control node. Generally, a server cluster includes a dozen machines and even dozens or hundreds of machines. If a problem occurs in a map switching process of a player, it is not convenient to view the log to locate the problem, and it is necessary to find the related machine and then check the log to locate the problem.

The embodiments of this application provide a virtual map switching method and apparatus, a server, a non-transitory computer-readable storage medium, and a computer program product, which can enhance the data security and the convenience of system security maintenance while improving the stability and switching effectiveness of map switching. The following illustrates an exemplary application of the server provided in the embodiments of this application.

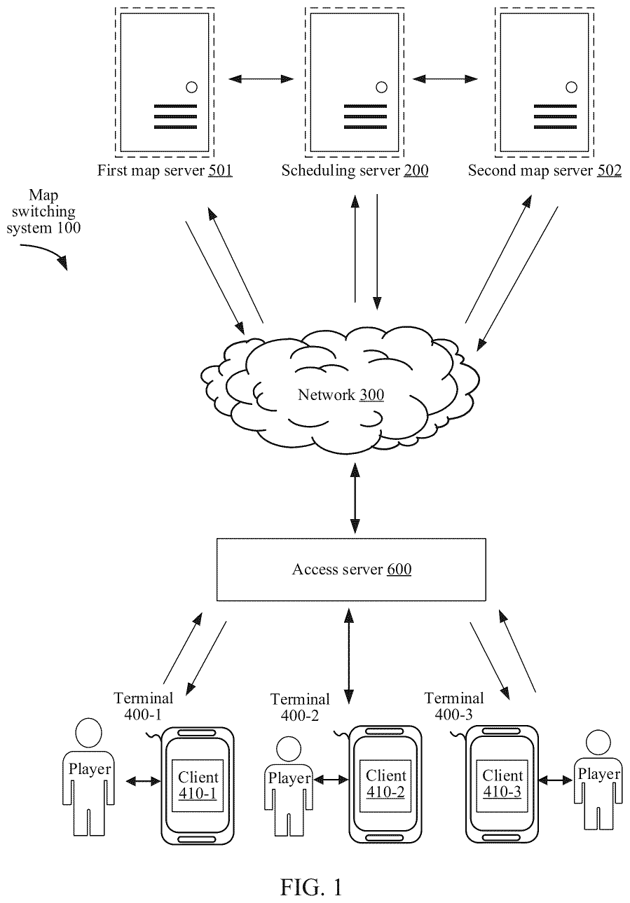

Referring to FIG. 1, FIG. 1 is a schematic architectural diagram of the map switching system 100 according to an embodiment of this application. The scheduling server provided in this embodiment of this application may be an independent physical server, or a server cluster or distributed system composed of a plurality of physical servers, or may be a cloud server that provides cloud services, cloud databases, and basic cloud services such as cloud computing, cloud functions, cloud storage, network services, cloud communications, middleware services, domain name services, security services, content delivery networks (CDN), big data, and artificial intelligence platforms. The cloud services may be communication processing services for a first terminal device 400-1, a second terminal device 400-2, or a third terminal device 400-3. The terminals 400-1 to 400-3 may be, but are not limited to: smartphones, tablets, laptops, desktop computers, smart speakers, smartwatches, smart voice interaction devices, smart home appliances, in-vehicle terminals, or the like. The terminal and the server may be directly or indirectly connected in wired or wireless communication mode, which is not limited in the embodiments of this application.

Still referring to FIG. 1, to implement a secure and effective map switching scenario (for example, a client needs to switch from a first map instance in a first map server to a second map instance in a second map server), as shown in FIG. 1, the map switching system 100 includes: terminals (for example, terminals 400-1, 400-2, and 400-3 are shown), a network 300, an access server 600, a scheduling server 200, a first map server 501, and a second map server 502. A network game client 410-1 is run on the terminal 400-1, a network game client 410-2 is run on the terminal 400-2, a network game client 410-3 is run on the terminal 400-3, and the network 300 may be a wide area network or a local area network, or a combination of a wide area network or a local area network.

In some embodiments, in response to that a player transmits a map switching request, by using the network game client 410-1 on the first terminal device 400-1, through the access server 600 and via the network 300, to the first map server 501 and then the first map server 501 transmits the map switching request to the scheduling server 200, for requesting to switch a first map run on the client 410-1 to a second map, for example, switching from a first map corresponding to a forest scene to a second map corresponding to a cave scene, the scheduling server 200 may select, after receiving the map switching request, a second map instance corresponding to the second map provided by the second map server 502; then, the scheduling server 200 transmits session data and character data to the second map server 502; the second map server 502 creates, after receiving the session data and the character data, a session with the client 410-1 and a virtual character according to the session data and the character data; then, the second map server 502 or the scheduling server 200 transmits a route setting request, via the network 300, to the access server 600; after receiving the request, the access server 600 sets the route of client 410-1 from pointing to the first map server 501 to pointing to the second map server 502; finally, the scheduling server 200 transmits a map switching response to the client 410-1; after receiving the map switching response, the client 410-1 performs a session with the second map instance in the second map server 502 through the access server 600, so as to control the virtual character in the second map, complete the map switching process, and implement stable and efficient map switching.

In other embodiments, this embodiment of this application may be implemented by using the cloud technology, which refers to a hosting technology that unifies series of resources such as hardware, software, and network in a wide area network or a local area network, to implement computing, storage, processing, and sharing of data.

The cloud technology is a generic term for a network technology, an information technology, an integration technology, a management platform technology, an application technology, and the like applied based on a cloud computing commercial mode, and can form a pool of resources, which is used on demand and is flexible and convenient. The cloud computing technology is to become an important support. Back-end services of a technology network system require a huge amount of computing and storage resources.

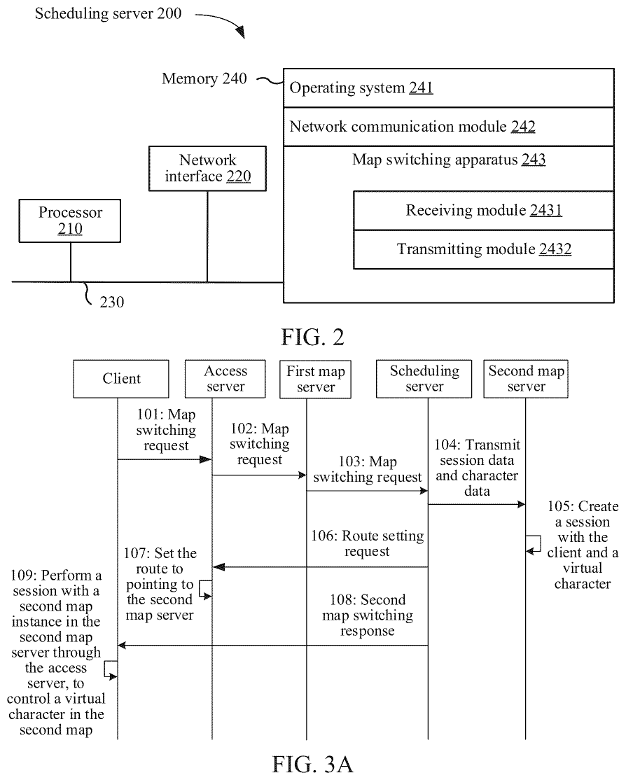

The following describes the structure of the scheduling server 200 shown in FIG. 1. Referring to FIG. 2, FIG. 2 is a schematic structural diagram of a scheduling server 200 according to an embodiment of this application. The scheduling server 200 shown in FIG. 2 includes: at least one processor 210, a memory 240, and at least one network interface 220. Components in the scheduling server 200 are coupled together by using a bus system 230. The bus system 230 is configured to implement connection and communication between the components. In addition to a data bus, the bus system 230 further includes a power bus, a control bus, and a state signal bus. But, for ease of clear description, all types of buses in FIG. 2 are marked as the bus system 230.

The processor 210 may be an integrated circuit chip with signal processing capabilities, such as a general-purpose processor, a digital signal processor (DSP), or other programmable logic devices, discrete gate or transistor logic devices, or discrete hardware components, where a general-purpose processor may be a microprocessor or any conventional processor.

The memory 240 may be removable, non-removable, or a combination thereof. Exemplary hardware devices include a solid state memory, a hard disk drive, an optical disc drive, and the like. In one embodiment, the memory 240 includes one or more storage devices located physically away from the processor 210.

The memory 240 includes a transitory memory or a non-transitory memory, or may include both a transitory memory and a non-transitory memory. The non-transitory memory may be a read-only memory (ROM) and the non-transitory memory may be random access memory (RAM). The memory 240 described in this embodiment of this application aims to include any suitable type of memories.

In some embodiments, the first memory 240 can store data to support various operations, examples of which include programs, modules, and data structures, or subsets or supersets thereof, as illustrated below.

An operating system 241 includes system programs for processing various basic system services and performing hardware-related tasks, such as a framework layer, a core library layer, or a driver layer, for implementing various basic services and processing hardware-based tasks.

A network communication module 242 is configured to reach another electronic device via one or more (wired or wireless) network interfaces 220. For example, the network interface 220 includes: Bluetooth, wireless fidelity (WiFi), and universal serial bus (USB), or the like.

In some embodiments, the map switching apparatus according to this embodiment of this application may be implemented in a software manner. FIG. 2 shows a map switching apparatus 243 stored in the memory 240, which may be software in the form of a program, a plug-in, or the like, including the following software modules: a receiving module 2431 and a transmitting module 2432; these modules are logical and therefore can be combined or split in different manners according to the functions to be implemented. The functions of the modules are to be explained below.

The following describes the map switching method according to the embodiments of this application from the perspective of interaction among a client, an access server, a first map server, a second map server, and a scheduling server.

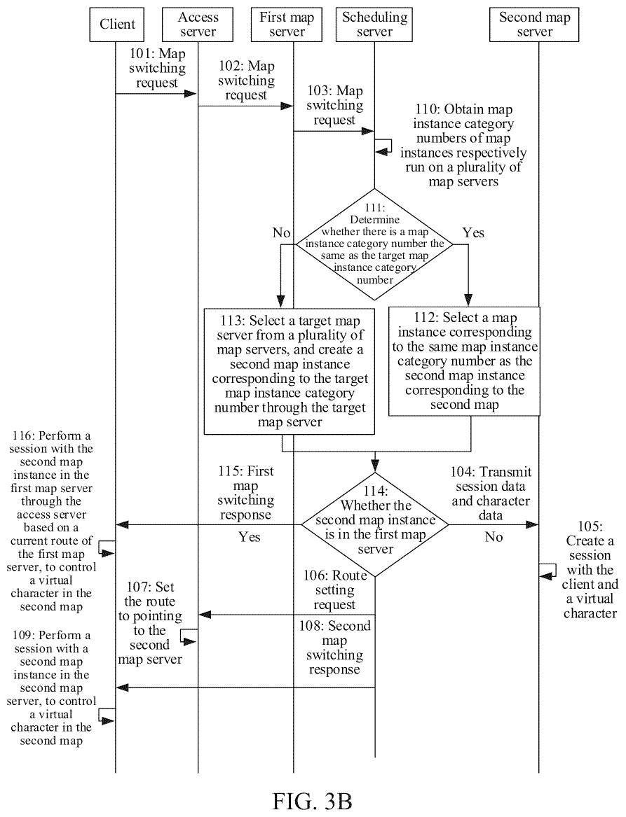

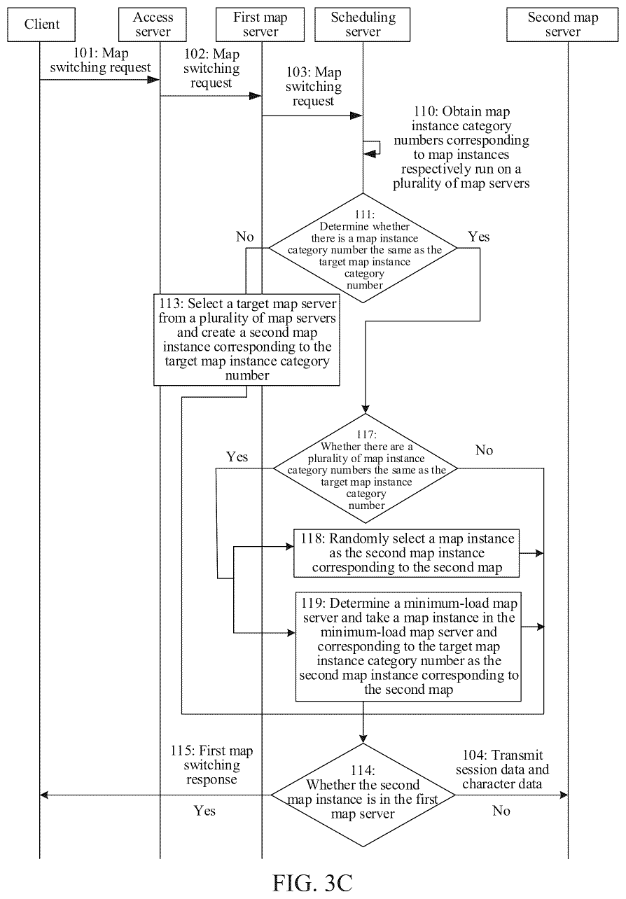

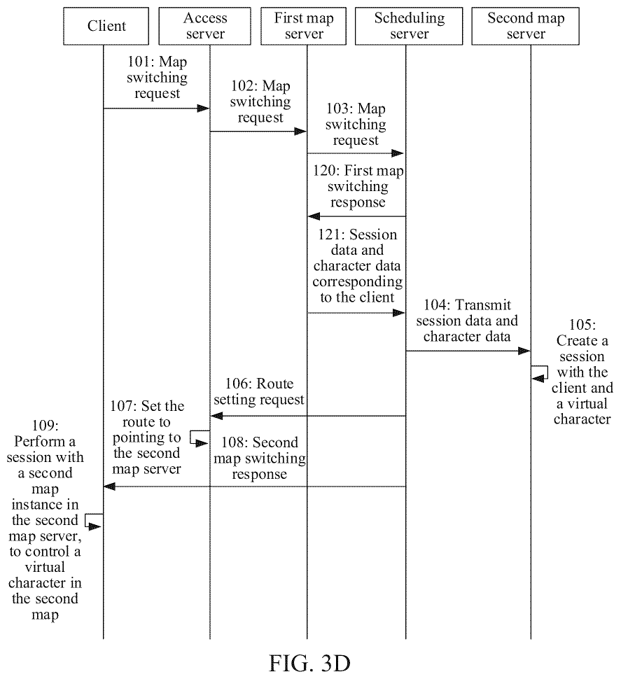

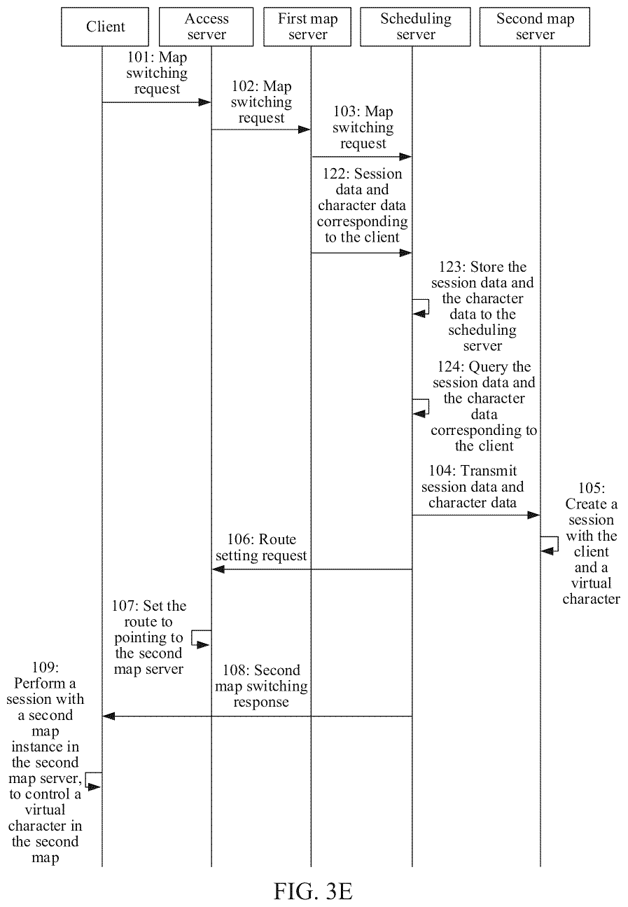

For example, referring to FIG. 3A, FIG. 3A is a schematic flowchart of a map switching method according to an embodiment of this application. A description is provided in combination with the operations shown in FIG. 3A.

Based on interaction with a first map on the first map server, the client transmits a map switching request to the scheduling server through the access server. The process is implemented in the following manner. Operation 101: The client transmits a map switching request to the access server. Operation 102: The access server transmits the map switching request to the first map server. Operation 103: The first map server transmits the map switching request to the scheduling server.

Here, in practical application, the client is installed on an electronic device, for example, installed on a terminal. When the terminal runs the client, the client may display the first map, the first map corresponds to the first map server, that is, a first map instance corresponding to the first map is in the first map server, and the first map is provided or generated by the first map server.

In some embodiments, messages transmitted by the client to the server need to be directed via the access server according to a routing direction. The map switching request instructs to switch the first map currently run (that is, displayed) on the client to a second map, and the first map instance corresponding to the first map is in the first map server.

In practical application, the second map corresponds to the second map server, in other words, a second map instance corresponding to the second map may be in the second map server, and the second map is provided or generated by the second map server. In some embodiments, the first map and the second map are interactive maps, and a user may input, on the client, an interactive instruction (for example, a map zooming instruction, or a map switching instruction) for information included in the interactive map, to cause the client to respond to the interactive instruction.

In some embodiments, when a virtual character on the client needs to perform map switching, the client may transmit a map switching request to the scheduling server through the access server and the first map server. In other words, first, the client transmits the map switching request to the access server, then the access server transmits the map switching request to the first map server, and then the first map server forwards the map switching request to the scheduling server; and in this case, the scheduling server can be informed of that the client needs to perform map switching.

A situation where a virtual character needs to perform map switching may include the following cases: 1. When the virtual character moves to a particular transfer point of the map, for example, when the virtual character boards an aircraft, switching from a land map to an aircraft map is triggered; 2. When a player clicks/taps on a user interface (UI) or a game activity, for example, when the player signs up for a particular gameplay activity, switching from a current map to an active map is triggered; 3. Due to the fact that a complete map in a massive game is composed of a plurality of sub-maps and the plurality of sub-maps are loaded in blocks by using different servers, when a virtual character controlled by a player moves to a boundary of a sub-map, switching to a sub-map in another server is triggered, and therefore when the virtual character controlled by the player roams and moves in the large map and walks to a boundary of a sub-map, switching to another sub-map is triggered; 4. When a virtual character controlled by a player goes to a scene trigger area, switching from a current scene map to another scene map is triggered, to enter another scene, for example, entering a cave from a mountain forest.
Operation 104: The scheduling server transmits session data and character data to the second map server in response to the map switching request.

Here, the second map is a target scene map during switching of the map by the player, the second map instance is a game map program that can be run on the second map server, the session data indicates that the first map server has a connection relationship with the client, and the character data indicates a character attribute of the virtual character in a virtual scene. In practical application, the session data may include: data such as network connection related information of the client (information of an accessed gateway, or device information of a connected network), or a device type of the client; the character data may include: backpack data, skill equipment data, character appearance data of the virtual character, or the like.

In some embodiments, before the scheduling server transmits the session data and the character data to the second map server, whether the session data and the character data can be transmitted to the second map server may be checked in the following manner: checking, by the scheduling server, login status of a current login account; and when the login status indicates that the current login account is non-logged in another map server, performing the operation of transmitting session data and character data to the second map server, so that the second map server creates a session with the client and a virtual character according to the received session data and character data.

In some embodiments, when the login status indicates that the current login account is being logged in to another map server, switching prompt information is transmitted to the client, and the switching prompt information is configured for indicating that the current login account is being logged in to another map server and map switching cannot be performed. If the current login account is being logged in to another map server in the map switching process, to prevent intersection between the map switching process and the login process, the map switching process is suspended due to the fact that the map switching condition is not met if the current login account is being logged in, so as to avoid other problems caused by concurrency.
Operation 105: The second map server creates a session with the client and a virtual character.

In some embodiments, after receiving the session data and the character data corresponding to the client transmitted by the scheduling server, the second map server creates a session with the client according to the received session data, and creates a virtual character in the second map according to the received character data.
Operation 106: The scheduling server transmits a route setting request to the access server.

In some embodiments, after the second map server creates the session with the client and the virtual character in the second map, in other words, when the scheduling server determines that creation of the session and the virtual character by the second map server is completed (for example, creation completion information returned by the second map server is received), the scheduling server may transmit a route setting request to the access server, and the route setting request instructs to set the route from pointing to the first map server to pointing to the second map server.

In other embodiments, a route setting request may also be transmitted from the second map server to the access server.
Operation 107: The access server sets the route to pointing to a second map server.

In some embodiments, the access server sets the route from pointing to the first map server to pointing to the second map server after receiving the route setting request transmitted by the scheduling server or the second map server, so that the message transmitted by the player to the access server no longer be transmitted to the first map server, but to the second map server.

In some embodiments, the access server may return a route setting completion message to the scheduling server after completing the route setting for the client.
Operation 108: The scheduling server transmits a second map switching response to the client.

Here, in practical application, the scheduling server may transmit the second map switching response to the client when determining that the access server completes the route setting for the client (for example, when receiving a route setting completion message returned by the access server), the second map switching response is configured for the client to perform a session with the second map server through the access server, and the session is configured for the client to control the virtual character in the second map; in practical application, the session may include a control instruction for controlling the virtual character in the second map, and when the second map server receives the control instruction through the session, a control operation for the virtual character may be performed based on the control instruction.
Operation 109: The client performs a session with the second map server through the access server, to control a virtual character in the second map.

In some embodiments, receipt, by the client, of the second map switching response transmitted by the scheduling server means that the map is switched from the first map server to the second map server in this case, and the client can perform a session with the second map instance in the second map server, to further control the virtual character in the second map, thereby successfully completing the map switching.

In this embodiment of this application, communication between the client and the access server may be maintained during the map switching, the current network connection of the client does not need to be disconnected, and further the client does not need to establish a new connection with a target map server through a wireless communication network signal, so that the network fault tolerance and the map switching efficiency are improved. In addition, the entire map switching process does not need to be driven by the client, so that even if a problem occurs in the client, such as script errors and crashes, the map switching process is not affected, thereby improving the system robustness.

In some embodiments, the server cluster managed by the scheduling server includes a plurality of map servers, and the plurality of map servers respectively run a plurality of map instances. To conveniently and quickly determine whether there is a second map instance corresponding to the second map needed by the map switching request among the plurality of map instances respectively run on the plurality of servers, a target map instance category number carried by the map switching request is configured for determining.

In some embodiments, the map switching request carries a target map instance category number. Referring to FIG. 3B, FIG. 3B is a schematic flowchart of the map switching method according to an embodiment of this application. Between foregoing operation 103 and operation 104, the scheduling server may further execute the following operation 110 to operation 114, which are described below respectively.
Operation 110: The scheduling server obtains map instance category numbers of map instances respectively run on a plurality of map servers.
Operation 111: The scheduling server determines whether a map instance category number which is the same as a target map instance category number exists in the map instance category numbers of the map instances respectively run on the plurality of map servers, and if the map instance category number which is the same as the target map instance category number exists, turn to operation 112, and if not, turn to operation 113.
Operation 112: The scheduling server selects a map instance corresponding to the same map instance category number as the second map instance corresponding to the second map.

In some embodiments, the scheduling server presets a relationship mapping table of map instance category numbers correlated with map instances. The map instance category numbers can be used to identify the corresponding map instances, in other words, the map instance category numbers can be used as identifiers of the map instances, each map instance category number corresponds to one map instance, and therefore, if the map instance category numbers are the same, the corresponding map instances are the same. In practical application, the map instance category number may carry at least one of the following information: a map scene corresponding to the corresponding map instance, a quantity of first virtual characters in the corresponding map instance, and a quantity of second virtual characters in the corresponding map instance.

For example, a map instance category number is x-y-r, where x represents a map scene, for example, number 1 represents a school scene, and number 2 represents a forest scene; y represents a quantity of first virtual characters in the map scene, and the first virtual characters are immovable, for example, trees and stones in the forest scene; and r represents a quantity of second virtual characters in the map scene, and the second virtual characters are movable, for example, other players, or virtual monsters.

In this way, according to the target map instance category number in the received map switching request transmitted by the client, whether there is a target map instance in the map instance respectively run on a plurality of map servers can be quickly determined, thereby effectively saving the map switching time, and further improving the map switching efficiency.
Operation 113: The scheduling server selects a target map server from a plurality of map servers and creates a second map instance corresponding to the target map instance category number through the target map server.

In some embodiments, both the second map instance selected in operation 112 or the second map instance created in operation 113 may be in a first map server or in any other map server. If the second map instance is in the first map server, the map switching process is switching within a same server, and if the second map instance is in any server other than the first map server, the map switching process is switching between different servers. Therefore, after operation 112 or operation 113, the scheduling server turns to operation 114. Operation 114: The scheduling server determines whether the second map instance is in the first map server, if yes, turns to operation 115 and operation 116, and if not, turns to operation 104 to operation 109.
Operation 115: The scheduling server transmits a first map switching response to the client in response to that the second map instance corresponding to the second map is in the first map server.

In some embodiments, if the second map instance corresponding to the second map is in the first map server, the first map switching response is directly transmitted to the client instead of being transmitted to the first map server.
Operation 116: The client performs a session with the second map instance in the first map server through the access server based on a current route of the first map server, to control a virtual character in the second map.

In some embodiments, if the scheduling server determines that there is a second map instance corresponding to the second map on the first map server according to the target map instance category number carried in the map switching request after receiving the map switching request, the map server is the same before and after the map switching, the scheduling server does not need to transmit session data and character data, and directly transmits the first map switching response to the client, so that the client performs a session with the second map instance in the first map server through the access server based on the current route of the first map server, and controls the virtual character in the second map to complete the map switching.

In other embodiments, if the scheduling server determines, according to a target map instance category number carried in the map switching request, that there is no map instance category number that is the same as the target map instance category number among the map instance category numbers of the map instances respectively run on a plurality of map servers, the scheduling server may select a target map server according to a load condition of the map servers and create a second map instance corresponding to the target map instance category number through the target map server. If the scheduling server determines that the load of the first map server is the lowest according to the load condition of the map servers, the scheduling server selects the first map server as the target map server to create the second map instance. In this case, the map server is the same before and after the map switching, and the scheduling server likewise does not need to transmit session data and character data, and directly transmits the first map switching response to the client, so that the client performs a session with the second map instance in the first map server through the access server based on the current route of the first map server, and controls the virtual character in the second map to complete the map switching.

In some embodiments, when determining, according to a target map instance category number in the map switching request sent by the client, that there are a plurality of map instances having map instance category numbers the same as the target map instance category number among the map instances respectively run on a plurality of map servers, the scheduling server may select a map instance from the plurality of map instances as the target map instance. Referring to FIG. 3C, which is based on FIG. 3A, FIG. 3C is a schematic flowchart of a map switching method according to an embodiment of this application. Between operation 110 and operation 104, operation 111 may further be performed. Operation 111: The scheduling server determines whether there is a map instance category number the same as the target map instance category number, if yes, operation 117 is performed, and if not, operation 113 is executed.
Operation 117: The scheduling server determines whether there are a plurality of map instance category numbers the same as the target map instance category number, if yes, the scheduling server may select a second map instance corresponding to the second map through the following operation 118 or operation 119; if not, there is only a unique map instance category number the same as the target map instance category number, and operation 114 is directly turned to, which has been described above and is not repeated herein.
Operation 118: The scheduling server randomly selects a map instance from the map instances corresponding to the plurality of map instance category numbers as the second map instance corresponding to the second map.
Operation 119: The scheduling server determines a minimum-load map server from the map servers where the map instances corresponding to the map instance category numbers are respectively located and takes a map instance in the minimum-load map server and corresponding to the target map instance category number as the second map instance corresponding to the second map.

A load of a server may indicate a current utilization rate of the server. When there are a plurality of map instances to be selected, a map instance run on a server having a lowest server load may be selected as the second map instance (the target map instance), to implement proper resource allocation. Certainly, if only a unique map instance category number the same as the target map instance category number is found according to the target map instance category number, the map instance corresponding to the map instance category number is directly taken as the second map instance. Assuming that the second map instance is in the second map server, operation 104 to operation 109 in FIG. 3A is continuously turned to (operation 104 to operation 109 are not shown in FIG. 3C).

In some embodiments, referring to FIG. 3D, FIG. 3D is a schematic flowchart of a map switching method according to an embodiment of this application. Based on FIG. 3A, between operation 103 to operation 104, session data and character data may be obtained by the following operation 120 to operation 121.
Operation 120: The scheduling server transmits a first map switching response to the first map server.
Operation 121: The first map server transmits session data and character data corresponding to the client to the scheduling server.

In some embodiments, the first map server caches session data and character data corresponding to the client, the session data indicates that the first map server has a connection relationship with the client, and the session data may include: data such as network connection related information of the client (information of an accessed gateway, or device information of a connected network), or a device type of the client, the character data indicates a character attribute of the virtual character in the virtual scene, and the character data may include: backpack data, skill equipment data, character appearance data of the virtual character, or the like. When the session data and the character data corresponding to the client change, the first map server updates the cached session data and character data. After receiving the first map switching response transmitted by the scheduling server, the first map server transmits the cached session data and character data corresponding to the client to the scheduling server. Certainly, to deal with data loss caused by a sudden abnormal situation, the first map server creates a data saving transaction to save data to a database before transmitting the session data and character data to the scheduling server, so that a reply can be provided from the database when an abnormal situation occurs, thereby avoiding data loss.

In other embodiments, referring to FIG. 3E, FIG. 3E is a schematic flowchart of a map switching method according to an embodiment of this application. Based on FIG. 3A, between operation 103 and operation 104, session data and character data may be obtained by operation 122 to operation 124.
Operation 122: The scheduling server receives the session data and the character data corresponding to the client actively transmitted by the first map server.

Here, in practical application, the first map server may transmit session data and character data in real time or periodically (the period may be set according to actual needs, such as 3 s).
Operation 123: The scheduling server stores the session data and the character data to the scheduling server.

Due to the fact that the first map server may provide services to a plurality of clients, when the first map server actively transmits session data and character data with the clients to the scheduling server in real time (for example, when there is data update on a client to which the first map server provides a service) or periodically (for example, every 10 min), the first map server may transmit the session data and the character data to the scheduling server in batches based on client identities, for example, the session data and the character data are transmitted to the scheduling server in batches by using serial numbers of the clients as the identities, so that the scheduling server can quickly distinguish corresponding session data and character data between the first map server and the different clients.
Operation 124: The scheduling server queries the session data and the character data corresponding to the client.

The session data indicates that the first map server has a connection relationship with the client, the character data indicates a character attribute of the virtual character in the virtual scene, and the scheduling server may query by using a client identity (for example, a serial number of the client) as an index.

In this embodiment of this application, by storing, by the scheduling server, the session data and the character data transmitted by the first map server, the first map server does not need to perform a database operation in the map switching process, thereby reducing the back-end data pressure and improving the map switching speed.

In other embodiments, if the scheduling server determines that there is no map instance category number the same as the target map instance category number among the map instance category numbers corresponding to the map instances respectively run on the plurality of map servers, a target map server is selected from the plurality of map servers, and a second map instance corresponding to the target map instance category number is created through the target map server.

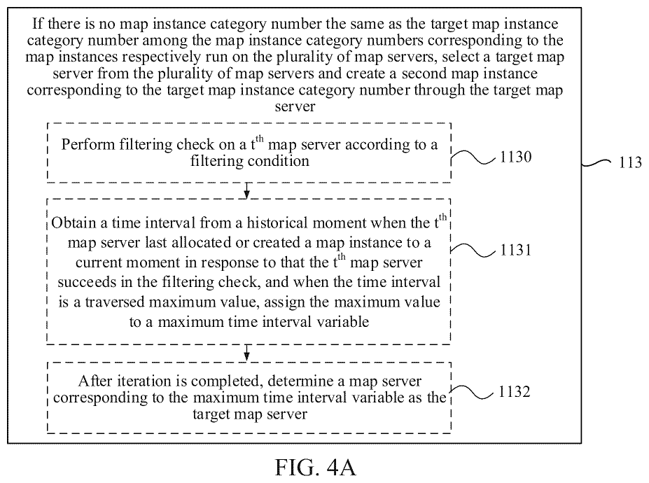

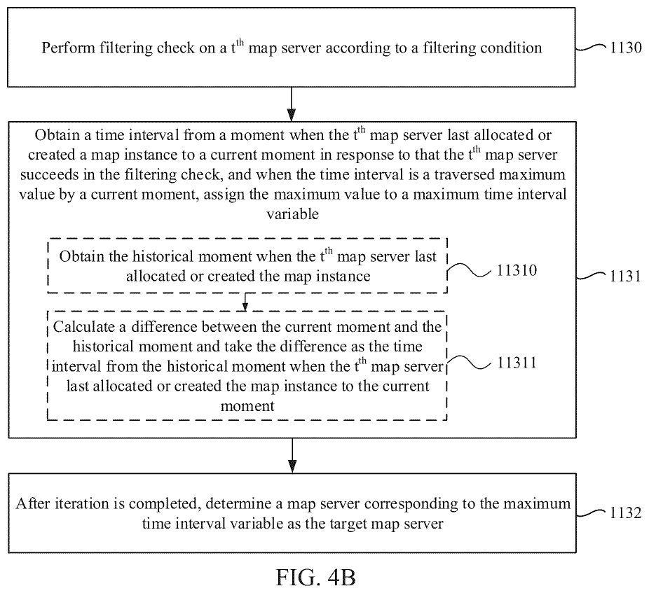

In some embodiments, the scheduling server may implement selection of the target map server iteratively by traversing a list of map servers based on the managed list of map servers. For example, referring to FIG. 4A, FIG. 4A is a schematic flowchart of a process for selecting a target map server according to an embodiment of this application. Operation 113 in FIG. 3B can be implemented by operation 1130 to operation 1132 in FIG. 4A. Operation 1130 to operation 1132 are performed iteratively.
Operation 1130: Perform filtering check on a t^{th} map server according to a filtering condition, where 1≤t≤T, T represents a quantity of the plurality of map servers, and both t and T are natural numbers.

Here, the filtering condition includes at least one of the following:
(1) A quantity of logged-in accounts in the t^{th} map server is greater than a threshold of a maximum quantity of logged-in accounts.

In this embodiment of this application, each map server may provide game services to a plurality of players. Due to the fact that a capacity of a server is limited, some quantity thresholds can be set to ensure normal operating of the server.

For example, for the second map server, if a maximum quantity of accounts allowed to log into the second map server is 100, a threshold of the quantity of logged-in accounts of the second map server is set to 80, and if the quantity of logged-in accounts in the second map server is 81, it means that a load of the second map server is relatively large and it is not suitable for creating a map instance. Therefore, the filtering condition is met, and filtering may be performed.
(2) A quantity of map instances run on the t^{th} map server is greater than a threshold of the quantity of map instances.

For example, still for the second map server, if a maximum quantity of map instances allowed to be run on the second map server is 100, a threshold of the quantity of map instances of the second map server is set to 80, and if the quantity of map instances already run on the second map server is 81, it means that a load of the second map server is relatively large and it is not suitable for creating a map instance. Therefore, the filtering condition is met, and filtering may be performed.
(3) A quantity of virtual characters existing in all map instances in the t^{th} map server is greater than a threshold of a quantity of virtual characters.

For example, still for the second map server, if a maximum quantity of virtual characters allowed to exist in the second map server is 500, a threshold of a quantity of virtual characters in the second map server is set to 450, and if the quantity of virtual characters already existing in the second map server is 440, it means that the second map server still has a remaining available space for creating a map instance. Therefore, the filtering condition is not met, and filtering is not performed.
(4) A utilization rate of a processor of the t^{th} map server is greater than a utilization rate threshold. For example, the processor may be a central processing unit, a graphics processing unit, or the like.
Operation 1131: Obtain a time interval from a historical moment when the t^{th} map server last allocated or created a map instance to a current moment in response to that the t^{th} map server succeeds in the filtering check, and when the time interval is a traversed maximum value, assign the maximum value to a maximum time interval variable.
Operation 1132: After iteration is completed, determine a map server corresponding to the maximum time interval variable as the target map server.

In some embodiments, referring to FIG. 4B, FIG. 4B is a schematic flowchart of a process for selecting a target map server according to an embodiment of this application. Operation 1131 shown in FIG. 4A may be implemented by operation 11310 to operation 11311 in FIG. 4B, which are described below respectively.
Operation 11310: Obtain the historical moment when the t^{th} map server last allocated or created the map instance.

In some embodiments, each map server records a moment of the operation when allocating a map instance for a client or creating a map instance on the server, and when a time interval needs to be calculated, the scheduling server first obtains a historical moment of previous (that is, the last) allocation or creation of a map instance saved by the t^{th} map server.
Operation 11311: Calculate a difference between the current moment and the historical moment and take the difference as the time interval from the historical moment when the t^{th} map server last allocated or created the map instance to the current moment.

In some embodiments, if the map server succeeds in the filtering check, it means that the map server has a remaining space for creating a map instance, and the scheduling server performs the filtering check on each map server in a list of map servers by traversing the list. In an example, if the 1st map server succeeds in the filtering check and the time interval of the 1st map server between a moment when a map instance was last allocated and a current moment is 10 min, 10 min is assigned to the maximum time interval variable. If the 2nd map server also succeeds in the filtering check and the time interval of the 2nd map server between a moment when a map instance was last allocated and a current moment is 15 min, 15 min is assigned to the maximum time interval variable. If the 3rd map server also succeeds in the filtering check and the time interval of the 3rd map server between a moment when a map instance was last allocated and a current moment is 10 min, a maximum time interval variable is still 15 min.

In this way, by selecting the target map server by using the maximum time interval, instantaneous high concurrency in the map switching process, that is, a case in which target map servers of a plurality of map switching requests are the same server can be dealt with. By using the method, a map instance creation task can be allocated to different map servers, thereby reducing the pressure on a single map server.

The embodiments of this application provide a solution for implementing map switching based on an access server. In the map switching process, a scheduling server and the access server work in coordination to implement a connection between a client and different servers by setting and changing a route direction of the access server, to ensure a communication connection between the client and the access server in the map switching process. The map switching can be implemented without disconnecting the existing network connection between the client and the access server. Due to the fact that the client does not need to disconnect the existing network connection, the client does not need to establish a new connection with a target server based on a mobile network signal, so that the network fault tolerance is improved. On the other hand, due to the fact that the client does not need to disconnect the existing network connection, the client does not need to save data to a database, and a target map server does not need to read data from the database, so that database operations are reduced and further the back-end data pressure is reduced. In addition, due to the fact that the map switching process does not need to be driven by the client, the map switching process does not stop due to problems in the client, such as script errors or crashes, thereby improving the system robustness. By controlling the map switching process by using the scheduling server a central control node, the map switching process is easy to manage, and when a problem occurs, it is easy for an administrator to maintain, thereby improving the convenience of system maintenance.

The following describes an exemplary application of the embodiments of this application in a practical application scenario in terms of interactions among the client, the access server, the first map server, the second map server, and the scheduling server.

In a massive multiplayer online game (MMOG), a player needs to operate a virtual object in the game to explore different game maps, and these maps are jointly maintained by a server cluster. When the virtual object controlled by the player needs to be switched from a map A to another map B, the two maps may be on different servers, for example, a first map server and a second map server.

The map switching solution of the related art is roughly divided into the following operations: The virtual object controlled by the player firstly logs out after data is saved in a source server, then the client disconnects a connection with the source server and establishes a connection with a target server, and subsequently the target server reads player character data from the database, reconstructs a game character according to session data attached by the client and the received character data, and then switches to a target map.

In other words, in the related art, the client needs to first disconnect from the source server before establishing a connection with the target server. In this way, disconnection of the client may occur in the process of disconnecting and creating a new connection, which may lead to termination of the map switching process, further leading to the relatively low effectiveness of the map switching. In addition, the whole switching process has no complete system control, and the data security and effective system security maintenance cannot be guaranteed.

In view of the above, the embodiments of this application provides a map switching method. The client of the embodiments of this application can communicate with the second map server by using the existing network connection, disconnection and reconstruction of network connections are not involved, and the whole switching process is controlled by the scheduling server as a central control node, so that the management and maintenance are convenient, the map switching process does not depend on the client, and the system is more robust.

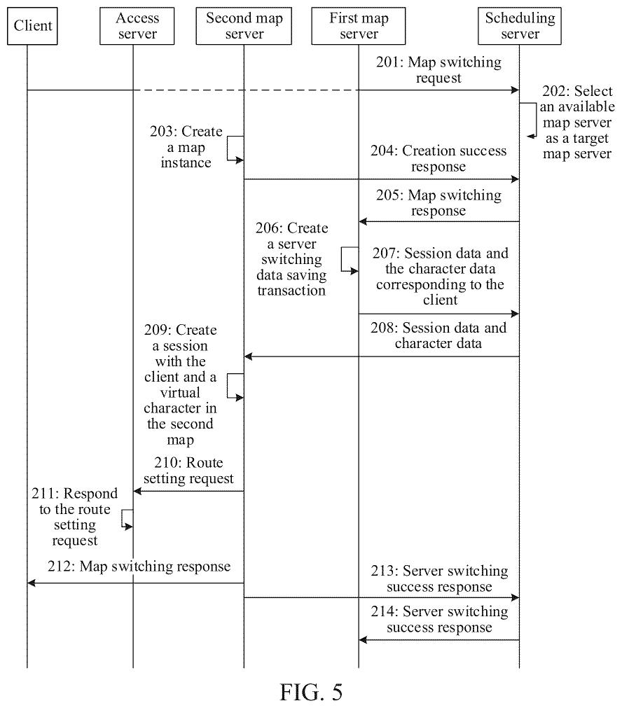

For example, referring to FIG. 5, FIG. 5 is a schematic flowchart of a map switching method according to an embodiment of this application. A description is provided in combination with FIG. 5.
Operation 201: The client transmits a map switching request to the scheduling server through the access server.

In some embodiments, a particular behavior of a player on the first map server, such as movement, an interaction with a non-player character (NPC) or a button of a game, may trigger map switching, a map switching request is transmitted to the first map server through the access server, and then the first map server transmits the map switching request to the scheduling server.
Operation 202: The scheduling server selects an available map server as a target map server.

In some embodiments, after receiving the map switching request, when the scheduling server discovers that there is no map instance the same as the target map instance in the map switching request among map instances that the map server can run, the scheduling server selects an available map server as the target map server from a map server cluster, to create a target map instance.

In some embodiments, the scheduling server first needs to learn about a load amount and a resource usage of the map servers in time to select an appropriate map server from the map server cluster to create a map instance. The process is completed by regularly or regularly reporting to the scheduling server by the map server. Reported information includes: 1) a current quantity of players on the map server; 2) a quantity of map instances currently run on the map server; 3) a quantity of virtual characters currently on the map server, for example, monster instances; and 4) a utilization rate of a processor currently on the map server, for example, a central processing unit or a graphics processing unit.

In some embodiments, it is assumed that the scheduling server selects the second map server as the target map server.
Operation 203: The second map server creates a map instance.

In some embodiments, it is assumed here that the scheduling server selects the second map server as the target map server, and that the second map server performs an operation of creating a map instance, and loads map-dependent resources, for example, physical resources and navigation grid resources.
Operation 204: The second map server transmits a creation success response to the scheduling server.
Operation 205: The scheduling server transmits a map switching response to the first map server.

In some embodiments, after receiving the creation success response transmitted by the target map server, the scheduling server transmits an ID of the second map server and an ID of the map instance created by the second map server to the first map server through the map switching response.
Operation 206: The first map server creates a server switching data saving transaction.

In some embodiments, after receiving the map switching response transmitted by the scheduling server, if the first map server determines, according to the ID of the map server and the ID of the target map instance, that the target map instance is not on the first map server, the first map server creates a server switching data saving transaction, which is specially configured for saving server switching data. The server switching data refers to session information data between the first map server and the client and virtual character data on the first map server. The transaction is a database transaction, which refers to a group of instructions specially configured for a database operation. Then the first map server sets the game character to a server switching outgoing state and saves the session data and the character data to the database. If the first map server determines, according to the ID of the map server and the ID of the target map instance, that the target map instance is on the first map server, there is no need to create a server switching data saving transaction.
Operation 207: The first map server transmits session data and character data corresponding to the client to the scheduling server.

In some embodiments, when establishing a connection with the client, the first map server caches session data and character data corresponding to the client, the session data indicates that the first map server has a connection relationship with the client, and the session data may include: data such as network connection related information of the client (information of an accessed gateway, or device information of a connected network), or a device type of the client, the character data indicates a character attribute of the virtual character in the virtual scene, and the character data may include: backpack data, skill equipment data, character appearance data of the virtual character, or the like. When the session data and the character data corresponding to the client change, the first map server updates the cached session data and character data. After receiving the first map switching response transmitted by the scheduling server, the first map server transmits the cached session data and character data corresponding to the client to the scheduling server.
Operation 208: The scheduling server transmits the session data and the character data to the second map server.
Operation 209: The second map server creates a session with the client and a virtual character in the second map.

In some embodiments, after receiving the session data and the character data transmitted by the scheduling server, the second map server creates a session with the client and a character on the second map server according to the session data and the character data, and the character is the same as the character on the first map server.
Operation 210: The second map server transmits a route setting request to the access server.

In some embodiments, after creation of the session and the character is completed, the second map server transmits a route setting request to the access server, or the request is transmitted by the scheduling server.
Operation 211: The access server responds to the route setting request.

In some embodiments, after receiving the route setting request, the access server sets the route from pointing to the first map server to pointing to the second map server, after which a message transmitted by the player from the client to the access server is to be transmitted to the second map server.

In the embodiments of this application, in the map switching process, the route is set to pointing to the second map server through the access server, so that the existing connection between the client and the network access server does not need to be disconnected during the map switching, and the problem of disconnection of the client during server switching is solved, thereby improving the stability and switching efficiency of the map switching.
Operation 212: The second map server transmits a map switching response to the client.
Operation 213: The second map server transmits a server switching success response to the scheduling server.

In some embodiments, when discovering that a communication is established with the client, the second map server transmits a server switching success response to the scheduling server, and the server switching success response is configured for indicating that the switching of the map server is successful.
Operation 214: The scheduling server transmits the server switching success response to the first map server.

In some embodiments, after receiving the server switching success response transmitted by the second map server, the scheduling server transmits a message to the first map server. After receiving the message, the first map server deletes character data corresponding to a character object in the server switching outgoing state.

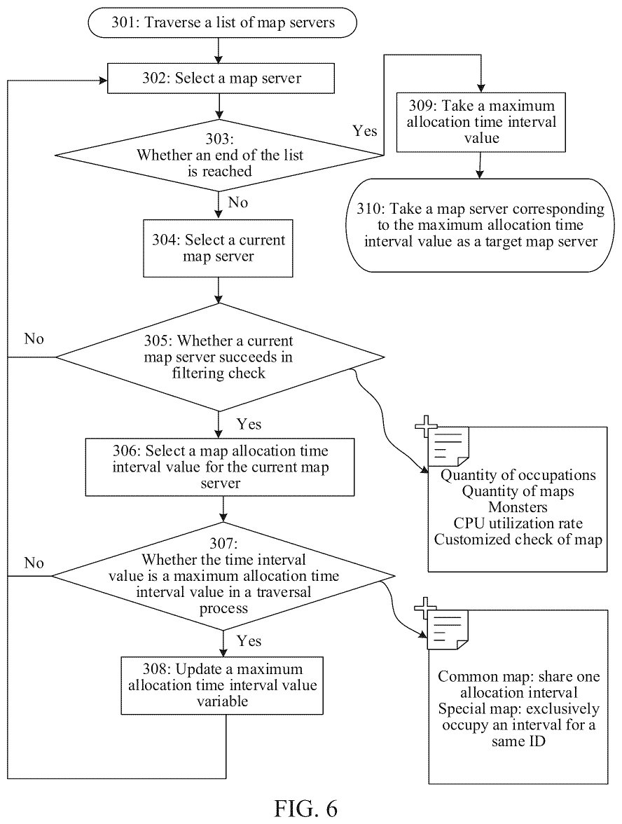

In some embodiments, operation 202 in FIG. 5 can be implemented by operation 301 to operation 309 in FIG. 6. Referring to FIG. 6, FIG. 6 is a schematic diagram of a process for selecting a target map server according to an embodiment of this application. The scheduling server manages a list of map servers that provide online services, and regularly updates information of the list according to the information reported by the map servers. To select an available map server as the target map server to create a map instance, the scheduling server can perform selection by traversing the list of map servers. A description is provided in combination with the following operations.
Operation 301: A scheduling server traverses a list of map servers.

In some embodiments, the scheduling server traverses according to an order of the list of map servers.
Operation 302: The scheduling server selects a map server.

In some embodiments, when traversal begins, the scheduling server first randomly selects a map server from the list as an initial traversal location.
Operation 303: The scheduling server determines whether an end of the list is reached; if not, operation 304 is turned to; and if so, operation 309 is turned to.

In some embodiments, after determining the initial traversal location, the scheduling server traverses all the map servers in the list according to the order of the list. For example, the map server at the initial traversal location may be labeled as 1. If the list of map servers includes 30 map servers in total, when traversing to a map server labeled as 30, it is determined that the end of the list is reached.
Operation 304: The scheduling server selects a current map server.

In some embodiments, after selecting the current map server, the scheduling server performs filtering check on the current map server according to a filtering condition.
Operation 305: The scheduling server determines whether the current map server succeeds in the filtering check.

In some embodiments, the filtering condition is at least one of the following: 1) whether a quantity of remaining idle occupations on the map server can allow a player to enter, and if not, the filtering condition is met; 2) whether a quantity of remaining idle map instances on the map server can allow a new map instance to be created for a player, and if not, the filtering condition is met; 3) whether a quantity of remaining idle virtual characters on the map server can allow a virtual character instance, for example, a monster instance, to be created for a map instance, and if not, the filtering condition is met; or 4) whether a utilization rate of a processor, for example, the central processor, of the map server is normal, and if the utilization rate of the processor is greater than a processor utilization rate threshold preset by the system, the filtering condition is met. There are also various other customized filtering conditions for specific replica types, which are not limited by the embodiments of this application.

In some embodiments, if the current map server succeeds in the filtering check, operation 306 is turned to; if not, operation 302 is turned to, and the scheduling server selects a next map server from the list and then operation 303 is performed.
Operation 306: The scheduling server selects a map allocation time interval value for the current map server.

In some embodiments, the scheduling server records a value of a time interval from a moment when a map instance was last allocated to current moment for each map server.
Operation 307: The scheduling server determines whether the time interval value is a maximum allocation time interval value in a traversal process; if yes, operation 308 is performed; if not, operation 302 is performed, the scheduling server selects a next map server from the list and then operation 303 is performed.

In some embodiments, there is a common map instance and a special map instance. The common map instance occupies a relatively small space and does not cause excessive load on the map server when the map instance is executed. The special map instance occupies a relatively large space and provides a service for a special player. The type of map instances use an exclusive allocation time interval, that is, the time interval of the map server is not considered for the maximum allocation time interval value.
Operation 308: The scheduling server updates a maximum allocation time interval value variable.

In some embodiments, the maximum allocation time interval value variable is exclusively configured for storing a maximum allocation time interval value encountered during traversal.

In some embodiments, after performing operation 308, the scheduling server returns to operation 302, selects a next map server from the list, and performs operation 303, until when the scheduling server determines that the end of the list is reached, and the scheduling server performs operation 309.
Operation 309: The scheduling server takes a maximum allocation time interval value.

In some embodiments, after the whole list of map servers is traversed, the value stored by the maximum allocation time interval value variable is taken as the maximum allocation time interval value.
Operation 310: The scheduling server takes a map server corresponding to the maximum allocation time interval value as a target map server.

In some embodiments, the method used above for selecting a target map server may also be another method, for example, a random method or a polling method. The random method includes the following operations. The scheduling server filters out, according to a filtering condition, a map server that does not meet the condition, and randomly selects a map server as the target map server from a plurality of map servers meeting a particular condition. The polling method includes the following operations. The scheduling server allocates map servers in turn according to the order of the managed list of map servers. For example, if the scheduling server selects the 3rd map server from the list of map servers as the target map server last time, when selecting a target map server currently, filtering check is directly performed on the 4th map server in the list according to the filtering condition. If the 4th map server succeeds in the filtering check, the 4th map server is taken as the target map server. Similarly, when selecting a map server next time, filtering check is directly performed on the 5th map server according to the filtering condition. If the 5th map server fails in the filtering check, filtering check is continuously performed on the 6th map server, and so on.

In the embodiments of this application, the maximum allocation time interval value is used to select the target map server, mainly because the map switching process may have instantaneous high concurrency, namely, target map servers of a plurality of map switching requests are the same server. By using the foregoing method, the high concurrency situation can be well dealt with, and the map switching requests are uniformly allocated to different map servers, so that the pressure on a single map server is reduced.

In the map switching method provided in the embodiments of this application, map switching without disconnecting an existing network connection of a client can be implemented based on an access server, so that the disconnection problem of the client in a process of disconnecting a connection and creating a new connection is solved, thereby improving the effectiveness of the map switching. In addition, the whole switching process is controlled by a scheduling server, and map switching in a virtual scene can be stably and efficiently implemented.

The following continuously describes an exemplary structure of the map switching apparatus 243 provided in the embodiments of this application as a software module. In some embodiments, as shown in FIG. 2, a software module stored in the map switching apparatus 243 in the memory 240 may include: a receiving module 2431 and a transmitting module 2432.

The receiving module 2431 is configured to configured to receive a map switching request transmitted by a client through an access server and a first map server, the map switching request being configured for instructing to switch a first map run on the client to a second map, the first map corresponding to the first map server, and the second map corresponding to a second map server.

The transmitting module 2432 is configured to transmit session data and character data to the second map server in response to the map switching request, the session data being configured for the second map server to create a session with the client, and the character data being configured for the second map server to create a virtual character in the second map.

The transmitting module 2432 is further configured to transmit a route setting request to the access server, the route setting request being configured for requesting the access server to set a route for the client to point to the second map server.

The transmitting module 2432 is further configured to transmit a second map switching response to the client, the second map switching response being configured for the client to perform the session with the second map server through the access server, the session being configured for the client to control the virtual character in the second map.

In some embodiments, the first map corresponds to a first map instance, the first map instance is in a first map server, the second map corresponds to a second map instance, the second map instance is in a second map server, and the map switching request carries a target map instance category number. The map switching apparatus 243 further includes a control module. The control module is configured to obtain map instance category numbers corresponding to map instances respectively run on the plurality of map servers; and configured to: if a map instance category number which is the same as the target map instance category number exists in the map instance category numbers corresponding to the map instances respectively run on the plurality of map servers, select a map instance corresponding to the same map instance category number as the second map instance corresponding to the second map.

In some embodiments, the control module is further configured to randomly select a map instance from the map instances corresponding to the plurality of map instance category numbers as the second map instance corresponding to the second map; and configured to determine a minimum-load map server from the map servers where the map instances corresponding to the map instance category numbers are respectively located, and take a map instance in the minimum-load map server and corresponding to the target map instance category number as the second map instance corresponding to the second map.

In some embodiments, the transmitting module is further configured to transmit a first map switching response to the client in response to that the second map instance corresponding to the second map is in the first map server, so that the client performs a session with the second map instance in the first map server through the access server based on a current route of the first map server, to control a virtual character in the second map.

In some embodiments, the control module is further configured to: if there is no map instance category number the same as the target map instance category number among the map instance category numbers corresponding to the map instances respectively run on the plurality of map servers, select a target map server from the plurality of map servers and create a second map instance corresponding to the target map instance category number through the target map server.

In some embodiments, the control module is further configured to perform filtering check on a t^{th} map server according to a filtering condition, where 1≤t≤T, T represents a quantity of the plurality of map servers; obtain a time interval from a historical moment when the t^{th} map server last allocated or created a map instance to a current moment in response to that the t^{th} map server succeeds in the filtering check, and when the time interval is a traversed maximum value by a current moment, assign the maximum value to a maximum time interval variable; and after iteration is completed, determine a map server corresponding to the maximum time interval variable as the target map server.

In some embodiments, the filtering condition includes at least one of the following: a quantity of logged-in accounts in the t^{th} map server is greater than a threshold of a maximum quantity of logged-in accounts; a quantity of map instances run on the t^{th} map server is greater than a threshold of the quantity of map instances; a quantity of virtual characters existing in all map instances in the t^{th} map server is greater than a threshold of a quantity of virtual characters; and a utilization rate of a processor of the t^{th} map server is greater than a utilization rate threshold.

In some embodiments the control module is further configured to obtain the historical moment when the t^{th} map server last allocated or created the map instance; and configured to calculate a difference between the current moment and the historical moment, and take the difference as the time interval from the moment when the t^{th} map server last allocated or created the map instance to the current moment.

In some embodiments, the control module is further configured to check login status of a current login account; and when the login status indicates that the current login account is non-logged in another map server, perform the operation of transmitting session data and character data to the second map server.

In some embodiments, the transmitting module is further configured to transmit a switching success response to the first map server, so that the first map server deletes character data corresponding to the virtual character on the first map server.

In some embodiments, the transmitting module is further configured to transmit a first map switching response to the first map server, so that the first map server transmits session data and character data corresponding to the client to the scheduling server, where the session data indicates a connection relationship between the first map server and the client, and the character data indicates a character attribute of the virtual character in the virtual scene.

In some embodiments, the receiving module is further configured to receive the session data and the character data corresponding to the client actively transmitted by the first map server and store the session data and the character data to the scheduling server, where the first map server actively transmits the session data and the character data in a periodic or real-time mode; and the control module is configured to query the session data and the character data corresponding to the client from the scheduling server, where the session data indicates that the first map server has a connection relationship with the client, and the character data indicates a character attribute of the virtual character in a virtual scene.

The descriptions of the apparatus in the embodiments of this application are similar to the foregoing descriptions of the method embodiments, and the apparatus embodiments have beneficial effects similar to those of the method embodiments, and therefore are not repeated herein. Technical details not to be exhausted in the instant messaging processing apparatus provided by the embodiments of this application can be understood with reference to the description of any one of FIG. 3A to FIG. 3E.

An embodiment of this application provides a computer program product or computer program, the computer program product or computer program including a computer instruction (that is, an executable instruction) stored in a non-transitory computer-readable storage medium. A processor of an electronic device reads the computer instruction from the computer-readable storage medium, and the processor executes the computer instruction, so that the electronic device performs the map switching method provided in the foregoing embodiments of this application.

An embodiment of this application provides a computer-readable storage medium, having an executable instruction stored therein, and the executable instruction, when executed by a processor, causing the processor to perform the map switching method according to the embodiments of this application, for example, the map switching method shown in FIG. 3A to FIG. 3E.

In some embodiments, the computer-readable storage medium may be a memory such as a read-only memory (ROM), a random access memory (RAM), an erasable programmable read-only memory (EPROM), an electrically erasable programmable read-only memory (EEPROM), a flash memory, a magnetic surface memory, an optical disk, or CD-ROM; or may be various devices including one or any combination of the foregoing memories.

In some embodiments, the executable instruction may be in a form of a program, software, a software module, scripts, or code, written in any form of programming language (including compiling or interpreting languages, or declarative or procedural languages), and may be deployed in any form, including being deployed as a stand-alone program or as a module, a component, a subroutine, or another unit suitable for use in a computing environment.

For example, the executable instructions may, but do not necessarily, correspond to a file in a file system, may be stored as part of a file holding other programs or data, for example, in one or more scripts stored in a hypertext markup language (HTML) document, in a single file exclusively used in a program in question, or in a plurality of collaborative files (for example, files having one or more modules, subroutines, or code portions stored therein).

For example, the executable instruction may be deployed for execution on one electronic device, or on a plurality of electronic devices located at one location, or on a plurality of electronic devices distributed at a plurality of locations and interconnected via a communication network.

The foregoing descriptions are merely exemplary embodiments of this application and are not intended to limit the scope of protection of this application. Any modification, equivalent replacement, or improvement made without departing from the spirit and principle of this application shall fall within the scope of protection of this application. In this application, the term “module” refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

What is claimed is:

1. A virtual map switching method performed by a computer device, the method comprising:
receiving a map switching request transmitted by a client, the map switching request instructing to switch the client from a first map corresponding to a first map server to a second map corresponding to a second map server;
transmitting session data and character data to the second map server in response to the map switching request, the session data instructing the second map server to create a session with the client, and the character data instructing the second map server to create a virtual character in the second map; and
transmitting a second map switching response to the client, the second map switching response instructing the client to perform the session with the second map server to control the virtual character in the second map.

2. The method according to claim 1, wherein the method further comprises:
in response to the map switching request, transmitting a route setting request to an access server, the route setting request instructing the access server to set a route for the client to point to the second map server.

3. The method according to claim 1, wherein the first map corresponds to a first map instance, the second map corresponds to a second map instance, and the map switching request carries a target map instance category number; and the method further comprises:
obtaining map instance category numbers of map instances respectively run on a plurality of map servers; and
selecting, among the plurality of map instance category numbers, a map instance corresponding to the same map instance category number as the second map instance.

4. The method according to claim 2, wherein the first map corresponds to a first map instance, the second map corresponds to a second map instance, and the map switching request carries a target map instance category number; and the method further comprises:
obtaining map instance category numbers of map instances respectively run on a plurality of map servers; and
when there is no map instance category number the same as the target map instance category number exist in the plurality of map instance category numbers, selecting a target map server from the plurality of map servers and creating the second map instance by using the target map server.

5. The method according to claim 4, wherein the selecting a target map server from the plurality of map servers comprises:
performing the following processing by using iteration t:
performing filtering check on a t^{th} map server according to a filtering condition, wherein 1≤t≤T, T represents a quantity of the plurality of map servers, and both t and T are natural numbers; obtaining a time interval from a historical moment when the t^{th} map server last allocated or created a map instance to a current moment in response to that the t^{th} map server succeeds in the filtering check, and when the time interval is a traversed maximum time interval, assigning the maximum time interval to a maximum time interval variable; and
after the iteration is completed, determining a map server corresponding to the maximum time interval variable as the target map server.

6. The method according to claim 5, wherein the filtering condition comprises at least one of the following:
a quantity of logged-in accounts in the t^{th} map server is greater than a threshold of a maximum quantity of logged-in accounts;
a quantity of map instances run on the t^{th} map server is greater than a threshold of the quantity of map instances;
a quantity of virtual characters in a map instance run on the t^{th} map server is greater than a threshold of a quantity of virtual characters; or
a utilization rate of a processor of the t^{th} map server is greater than a utilization rate threshold.

7. The method according to claim 1, wherein before the transmitting session data and character data to the second map server, the method further comprises:
checking login status of a current login account; and
when the login status indicates that the current login account is non-logged in another map server, performing the operation of transmitting session data and character data to the second map server.

8. The method according to claim 1, wherein after the transmitting a second map switching response to the client, the method further comprises:
transmitting a switching success response to the first map server, the switching success response instructing the first map server to delete character data corresponding to the virtual character on the first map server.

9. The method according to claim 1, wherein before the transmitting session data and character data to the second map server, the method further comprises:
receiving the session data and the character data corresponding to the client from the first map server, wherein
the session data indicates that the first map server has a connection relationship with the client, and the character data indicates a character attribute of the virtual character in a virtual scene.

10. A computer device comprising:
a memory, configured to store an executable instruction; and
a processor, configured to implement, when executing the executable instruction stored in the memory, a virtual map switching method including:
receiving a map switching request transmitted by a client, the map switching request instructing to switch the client from a first map corresponding to a first map server to a second map corresponding to a second map server;
transmitting session data and character data to the second map server in response to the map switching request, the session data instructing the second map server to create a session with the client, and the character data instructing the second map server to create a virtual character in the second map; and
transmitting a second map switching response to the client, the second map switching response instructing the client to perform the session with the second map server to control the virtual character in the second map.

11. The computer device according to claim 10, wherein the method further comprises:
in response to the map switching request, transmitting a route setting request to an access server, the route setting request instructing the access server to set a route for the client to point to the second map server.

12. The computer device according to claim 10, wherein the first map corresponds to a first map instance, the second map corresponds to a second map instance, and the map switching request carries a target map instance category number; and the method further comprises:
obtaining map instance category numbers of map instances respectively run on a plurality of map servers; and
selecting, among the plurality of map instance category numbers, a map instance corresponding to the same map instance category number as the second map instance.

13. The computer device according to claim 11, wherein the first map corresponds to a first map instance, the second map corresponds to a second map instance, and the map switching request carries a target map instance category number; and the method further comprises:
obtaining map instance category numbers of map instances respectively run on a plurality of map servers; and
when there is no map instance category number the same as the target map instance category number exist in the plurality of map instance category numbers, selecting a target map server from the plurality of map servers and creating the second map instance by using the target map server.

14. The computer device according to claim 13, wherein the selecting a target map server from the plurality of map servers comprises:
performing the following processing by using iteration t:
performing filtering check on a t^{th} map server according to a filtering condition, wherein 1≤t≤T, T represents a quantity of the plurality of map servers, and both t and T are natural numbers; obtaining a time interval from a historical moment when the t^{th} map server last allocated or created a map instance to a current moment in response to that the t^{th} map server succeeds in the filtering check, and when the time interval is a traversed maximum time interval, assigning the maximum time interval to a maximum time interval variable; and
after the iteration is completed, determining a map server corresponding to the maximum time interval variable as the target map server.

15. The computer device according to claim 14, wherein the filtering condition comprises at least one of the following:
a quantity of logged-in accounts in the t^{th} map server is greater than a threshold of a maximum quantity of logged-in accounts;
a quantity of map instances run on the t^{th} map server is greater than a threshold of the quantity of map instances;
a quantity of virtual characters in a map instance run on the t^{th} map server is greater than a threshold of a quantity of virtual characters; or
a utilization rate of a processor of the t^{th} map server is greater than a utilization rate threshold.

16. The computer device according to claim 10, wherein before the transmitting session data and character data to the second map server, the method further comprises:
checking login status of a current login account; and
when the login status indicates that the current login account is non-logged in another map server, performing the operation of transmitting session data and character data to the second map server.

17. The computer device according to claim 10, wherein after the transmitting a second map switching response to the client, the method further comprises:
transmitting a switching success response to the first map server, the switching success response instructing the first map server to delete character data corresponding to the virtual character on the first map server.

18. The computer device according to claim 10, wherein before the transmitting session data and character data to the second map server, the method further comprises:
receiving the session data and the character data corresponding to the client from the first map server, wherein
the session data indicates that the first map server has a connection relationship with the client, and the character data indicates a character attribute of the virtual character in a virtual scene.

19. A non-transitory computer-readable storage medium, having an executable instruction stored therein, and the executable instruction, when executed by a processor of a computer device, causing the computer device to implement a virtual map switching method including:
receiving a map switching request transmitted by a client, the map switching request instructing to switch the client from a first map corresponding to a first map server to a second map corresponding to a second map server;
transmitting session data and character data to the second map server in response to the map switching request, the session data instructing the second map server to create a session with the client, and the character data instructing the second map server to create a virtual character in the second map; and
transmitting a second map switching response to the client, the second map switching response instructing the client to perform the session with the second map server to control the virtual character in the second map.

20. The non-transitory computer-readable storage medium according to claim 19, wherein the method further comprises:
in response to the map switching request, transmitting a route setting request to an access server, the route setting request instructing the access server to set a route for the client to point to the second map server.
